(19) United States
(12) Patent Application Publication
(10) Pub. No.: US 2024/0159905 A1
(43) Pub. Date: May 16, 2024

(54) FMCW LIDAR SYSTEM WITH INTEGRATED RECEIVING OPTICS FOR MULTIPLE CHANNELS

(71) Applicant: Infoworks Co., Ltd, Seoul (KR)

(72) Inventor: Yong sun LEE, Hwaseong-si (KR)

(73) Assignee: Infoworks Co., Ltd, Seoul (KR)

(21) Appl. No.: 18/472,483

(22) Filed: Sep. 22, 2023

(30) Foreign Application Priority Data
Nov. 16, 2022 (KR) 10-2022-0153377

(51) Int. Cl. G01S 17/34; G01S 7/481

(52) U.S. Cl. CPC G01S 17/34; G01S 7/4814; G01S 7/4816

(57) ABSTRACT

The present invention relates to a frequency modulated continuous wave (FMCW) light detection and ranging (LiDAR) system with an integrated receiving optics for multiple channels, in which receiving optics are integrally configured and used for multiple channels, thereby simplifying assembly and manufacturing processes, infinitely expanding transmitting optics, improving angular resolution for vertical and horizontal fields of view, and preventing noise and performance degradation caused by crosstalk.

### CROSS-REFERENCE TO RELATED APPLICATION

This application claims the benefit of Korean Patent Application No. 10-2022-0153377, filed on Nov. 16, 2022, in the Korean Intellectual Property Office, the disclosure of which is incorporated herein in its entirety by reference.

### BACKGROUND

### 1. Field

The present invention relates to a frequency modulated continuous wave (FMCW) light detection and ranging (LiDAR) system with an integrated receiving optics for multiple channels, and more particularly, to an FMCW LiDAR system in which receiving optics are integrally configured and used for multiple channels, thereby simplifying assembly and manufacturing processes, infinitely expanding a transmitting optics, improving angular resolution for vertical and horizontal fields of view, and preventing noise and performance degradation caused by crosstalk.

### 2. Description of Related Art

Light detection and ranging (LiDAR) is a technology that irradiates a specific object with a laser to detect the distance to the specific object and the direction, speed, temperature, material distribution, and concentration characteristics of the specific object.

LiDAR utilizes the advantages of laser that can generate pulse signals with high energy density and short period, and is used for more precise distance measurement and observation of physical properties in the atmosphere. In addition, LiDAR is mounted on aircraft, satellites, and the like and is used for precise atmospheric analysis and observation of the global environment. Recently, the importance of LiDAR is gradually increasing as LiDAR is used as a core technology for three-dimensional (3D) reverse engineering and laser scanners and 3D video cameras for future autonomous vehicles.

Distance measurement using a laser is mainly classified into a pulsed time of flight (TOF) technology that measures a round trip time of a pulse, a phase shift technology that measures a distance through a phase difference of a signal, and a frequency modulated continuous wave (FMCW) technology that changes a frequency and then extracts distance information through a frequency difference. The TOF technology measures a distance by emitting a pulse signal from a laser and measuring the time taken for pulse signals reflected from objects within a measurement range to arrive at a receiver. The TOF technology shows excellent performance, but the system size is large and high cost is required. Therefore, the phase shift or FMCW technology is mainly used in low-cost distance measurement systems.

However, in an existing FMCW LiDAR, system performance is limited by signal shaking or crosstalk, and system performance is limited by nonlinearity of frequency change. In particular, in order to configure a multiple channel transmitting/receiving optics in an FMCW LiDAR, the transmitting/receiving optics has to be arranged and configured for each channel. Accordingly, as the number of channels increases, the number of optical components such as lenses and mirrors increases, resulting in an increase in costs.

Additionally, in the case of configuring a multiple channel transmitting/receiving optics in an FMCW LiDAR, in order to use the transmitting/receiving optics in an integrated manner, an optical circulator is applied to one collimator lens, and light emitted from a laser used for input and light reflected from a target interfere with each other to obtain distance information of the target. However, there has been a problem in that noise occurred in distance information of the target due to crosstalk in the circulator and a signal-to-noise ratio (SNR) of a measurement signal deteriorated.

Therefore, the present invention provides an FMCW LiDAR in which a receiving optics is configured by integrating a lens assembly and a tapered fiber, thereby simplifying assembly and manufacturing processes, infinitely expanding a transmitting optics, improving angular resolution for vertical and horizontal field of view, and preventing noise and performance degradation due to crosstalk.

Next, the prior inventions pertaining to the technical field of the present invention are described in brief, and then, the technical details that the present invention seeks to achieve differently compared to the prior inventions are described.

First, Korean Patent Registration No. 2050632 (2019 Dec. 3) is a prior art relating to a multiple channel LiDAR sensor module including at least one pair of light emitting units that emit a laser beam, and a light receiving unit formed between the at least one pair of light emitting units and receiving at least one pair of reflected laser beams emitted from the at least one pair of light emitting units and reflected from an object.

In addition, Korean Patent Registration No. 1296780 (2013 Aug. 14) is a prior art relating to an obstacle detection device and method using a laser. The obstacle detection device includes a laser light source that generates a laser beam, a camera that captures a front image and a front laser beam irradiation image by emitting the laser beam generated from the laser light source, and an image processing device that processes the images captured by the camera.

However, in the present invention, the receiving optics is configured by integrating a lens assembly and a tapered optical fiber. Therefore, there is a significant structural difference between the present invention and Korean Patent Registration No. 2050632, which describes the multiple channel LiDAR sensor module capable of measuring at least two objects with one image sensor, and Korean Patent Registration No. 1296780, which describes the obstacle detection device and method using a laser that can accurately detect obstacles in various environments.

### SUMMARY

The present invention has been made in an effort to solve the above-described problems, and an object of the present invention is to provide a frequency modulated continuous wave (FMCW) light detection and ranging (LiDAR) system that can be utilized for multiple channels by integrating receiving optics through integration of a lens assembly and a tapered optical fiber.

Another object of the present invention is to provide an FMCW LiDAR system that can simplify assembly and manufacturing processes by lowering the difficulty of the process through an integrated receiving optics for multiple channels.

Still another object of the present invention is to provide an FMCW LiDAR system that enables infinite expansion of a transmitting optics separately from an integrated receiving optics and improves angular resolution for vertical and horizontal fields of view.

Further another object of the present invention is to provide an FMCW LiDAR system that uses a transmitting optics and a receiving optics separately, thereby preventing noise and signal-to-noise (SNR) degradation due to crosstalk caused by the use of an optical circulator.

An FMCW LiDAR system with an integrated receiving optics for multiple channels according to an embodiment of the present invention may include: a receiving optical unit configured to receive reflection signals for each channel reflected from at least one object; and a signal transmitting unit connected to one side of the receiving optical unit, wherein the receiving optical unit and the signal transmitting unit may be integrally formed to simultaneously receive the reflection signals for each channel.

In addition, the FMCW LiDAR may further include: at least one transmitting optical unit configured to collimate a laser into parallel light and outputs the collimated light; and a signal processing module configured to calculate distance information of the object based on the reflection signal inputted through the signal transmitting unit.

In addition, the transmitting optical unit may be configured independently for each channel to emit a laser to each of the at least one object.

In this case, the number of the transmitting optical unit may be increased according to an increase in the number of channels, so as to improve angular resolution for a horizontal or vertical measurement field of view.

In addition, the receiving optical unit may be configured to simultaneously receive the reflection signals outputted for each channel and reflected from the at least one object and to output the simultaneously received reflection signals to the signal processing module through the signal transmitting unit.

In addition, the transmitting optical unit may be configured to adjust a frequency differently for each channel.

In addition, the signal transmitting unit may be an optical fiber that is a tapered fiber in which one side thereof is formed to have a wider area than the other side thereof and which is gradually tapered from the one side to the other side.

In addition, the receiving optical unit may include at least one lens having different shapes and sizes, so as to increase a reception rate of the reflection signal and reduce a reception error based on a combination of the at least one lens.

In addition, the FMCW LiDAR system may independent use the receiving optical unit and the transmitting optical unit, so as to prevent noise and a decrease in signal-to-noise ratio (SNR) due to crosstalk.

Furthermore, an operating method of an FMCW LiDAR system with an integrated receiving optics for multiple channels according to an embodiment of the present invention may include: collimating a laser beam into parallel light for each channel through at least one transmitting optical unit and outputting the collimated light to at least one object; simultaneously receiving reflection signals for each channel reflected from the at least one object through a receiving optical unit; outputting the reflection signals received for each channel to a signal processing module through a signal transmitting unit integrally connected to one side of the receiving optical unit; and calculating distance information of the object based on the reflection signals received for each channel through the signal processing module.

### BRIEF DESCRIPTION DRAWINGS

FIG. 1 is a diagram for describing the configuration of a multiple channel transmitting/receiving optics and the configuration of an optical circulator in an existing frequency modulated continuous wave (FMCW) light detection and ranging (LiDAR) system.

FIG. 2 is a diagram schematically illustrating the configuration of an FMCW LiDAR system with an integrated receiving optics for multiple channels according to an embodiment of the present invention.

FIGS. 3(a) and 3(b) are a diagram illustrating an example in which a receiving optics and a signal transmitting unit are integrally formed in the FMCW LiDAR system according to an embodiment of the present invention.

FIG. 4 is a detailed diagram illustrating the configuration of the FMCW LiDAR system with an integrated receiving optics for multiple channels according to an embodiment of the present invention.

FIG. 5 is a diagram detail illustrating the configuration of an FMCW LiDAR system with an integrated receiving optics for multiple channels according to another embodiment of the present invention.

FIG. 6 is a flowchart showing in detail an operation process of an FMCW LiDAR system operation method with an integrated receiving optics for multiple channels according to an embodiment of the present invention.

### DETAILED DESCRIPTION

Hereinafter, specific embodiments of the present disclosure will be described in detail with reference to the drawings. However, the spirit of the present invention is not limited to the presented embodiments, and those of ordinary skill in the art who understand the spirit of the present invention can easily suggest other degenerative inventions or other embodiments falling within the scope of the present invention through addition, change, deletion, and the like of other elements within the scope of the same spirit. However, this will also be said to fall within the scope of the present invention.

In addition, elements having the same functions within the scope of the same idea shown in the drawings of each embodiment are denoted by the same reference numerals.

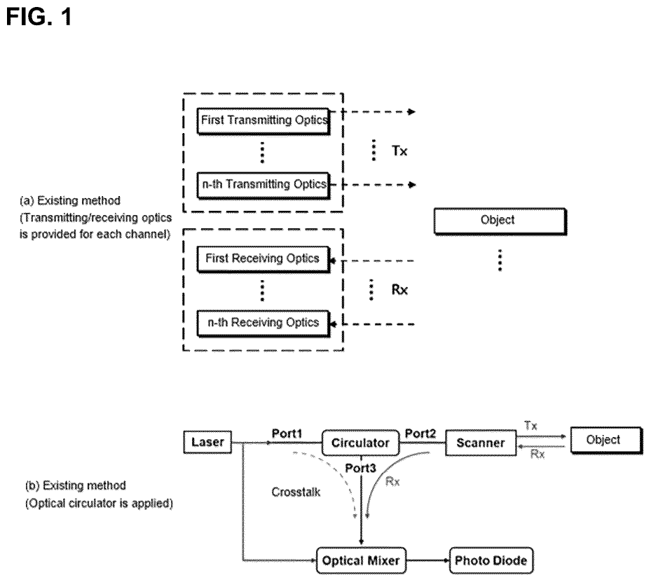

FIG. 1 is a diagram for describing the configuration of a multiple channel transmitting/receiving optics and the configuration of an optical circulator in an existing frequency modulated continuous wave (FMCW) light detection and ranging (LiDAR) system.

When configuring a multiple channel transmitting/receiving optics in an existing FMCW LiDAR, two major methods have been proposed and used as follows.

As illustrated in (a) of FIG. 1, the first method is to align and use a plurality of transmitting optics and a plurality of receiving optics. One transmitting optics and one receiving optics are provided for each channel.

However, if the transmitting optics and the receiving optics are configured separately for each channel, the number of optical components increases in proportion to the number of channels. This causes space constraints and complicates the system configuration.

As illustrated in (b) of FIG. 1, the second method for improving the first method is to apply an optical circulator to one collimation lens in order to integrally use a transmitting optics and a receiving optics. The second method has the advantage of reducing the number of optical components and resolving the difficulty of aligning the transmitting optics and the receiving optics.

As described above, the FMCW LiDAR system, to which the optical circulator is applied, calculates distance information of an object by interfering light from a laser used for input (i.e., port 1 in FIG. 1) with light Rx reflected from the object and received through port 3.

However, in this process, due to a crosstalk phenomenon in which the light from port 1 leaks to port 3, the light reflected from the object and the light cross talked in the circulator are obtained together in port 3. In other words, the laser used for input, the signal reflected from the object, and the crosstalk leaking from port 1 to port 3 of the circulator are used as signals for calculating the distance information of the object. Accordingly, there has been a problem in that interference occurred, thus causing noise in the distance information of the object and deteriorating a signal-to-noise (SNR) of a measurement signal.

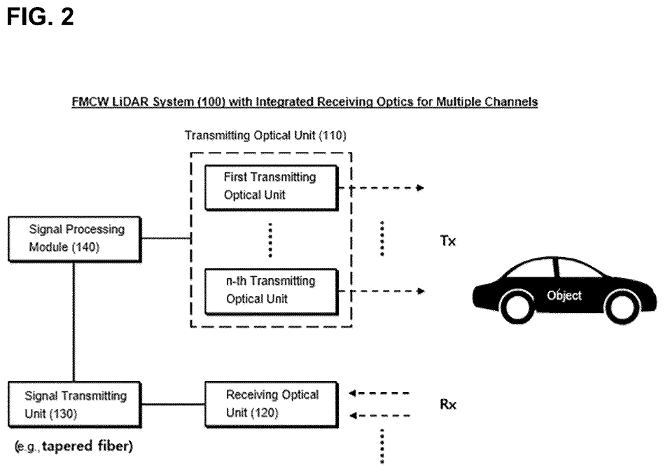

The present invention aims to solve problems occurring when a multiple channel transmitting/receiving optics in an existing FMCW LiDAR system, and a more detailed description is given below with reference to FIGS. 2 to 6.

FIG. 2 is a diagram schematically illustrating the configuration of an FMCW LiDAR system with an integrated receiving optics for multiple channels according to an embodiment of the present invention.

As illustrated in FIG. 2, an FMCW LiDAR system 100 with an integrated receiving optics for multiple channels (hereinafter referred to as FMCW LiDAR system) according to an embodiment of the present invention is configured to include at least one (preferably at least two) transmitting optical unit 110, one receiving optical unit 120, a signal transmitting unit 130, a signal processing module 140, and the like.

As an example, the FMCW LiDAR system 100 may be applied to autonomous vehicles.

The transmitting optical unit 110 emits a laser toward an object located at a predetermined distance (e.g., another vehicle subject to distance measurement, etc.) under the control of a control module (not shown).

At this time, the transmitting optical unit 110 collimates the laser into parallel light and outputs the collimated laser at a predetermined angle. Collimation means aligning a traveling direction of the laser to be parallel to a reference optical axis.

More specifically, the laser used in the FMCW LiDAR system 100 has excellent straightness properties compared to other light sources. However, since the laser used in the FMCW LiDAR system 100 diverges, a small amount of laser may be incident on the object. If the amount of laser incident on the object is small, the amount of laser reflected from the object also decreases, making it impossible to obtain a desired measurement result. In addition, on the contrary, if the degree of divergence of the emitted laser is large, a measurement distance may be reduced. Therefore, the degree of divergence of the laser has to be reduced by placing the transmitting optical unit 110 on the optical path of the laser and collimating the laser into parallel light.

On the other hand, the transmitting optical unit 110 may be configured independently for each channel, and a laser may be emitted to at least one object through each transmitting optical unit.

For example, when the number of channels of the FMCW LiDAR system 100 is set to 3, three transmitting optical units 110 may be configured according to the number of channels. That is, the number of transmitting optical units 110 may be increased according to the number of channels.

This is one of the main features of the present invention. The FMCW LiDAR system 100 may be configured to infinitely expand the transmitting optical unit according to the number of channels while using the transmitting optics and the receiving optics separately. In addition, due to the infinite expansion of the transmitting optical unit, the present invention may obtain the advantage of improving angular resolution for vertical and horizontal measurement fields of view.

Furthermore, the transmitting optical unit 110 can also output a laser by adjusting a frequency differently for each channel.

That is, the laser with different frequencies is emitted through the transmitting optical unit 110 for each channel, the reflection signal reflected from the object is received through the receiving optical unit 120, and the signal processing module 140 may calculate distance information of the object through comparison for each frequency.

The receiving optical unit 120 executes a function of simultaneously receiving reflection signals for each channel reflected from at least one object.

In other words, when the laser emitted from the first to n-th transmitting optical units 110, one for each channel, is reflected from the object, the receiving optical unit 120 simultaneously receives the reflection signals for each channel through one receiving optics and transmits the simultaneously received reflection signals for each channel to the signal processing module 140 through the signal transmitting unit 130.

This is one of the main features of the present invention. The FMCW LiDAR system 100 can simultaneously receive the reflection signals for each channel through one receiving optical unit. In addition, since there is no need to independently configure the receiving optical unit for each channel, the process alignment can be simplified, and thus, assembly and manufacturing processes can be simplified.

On the other hand, since the FMCW LiDAR system 100 implements the transmitting optical unit 110 and the receiving optical unit 120 as independent and separate configurations, it is possible to solve the problem of noise and SNR deterioration caused by crosstalk occurring when an existing optical circulator is used.

The signal transmitting unit 130 is integrally connected to one side of the receiving optical unit 120 and transmits, to the signal processing module 140, the reflection signals simultaneously received for each channel by the receiving optical unit 120. That is, since the receiving optical unit 120 and the signal transmitting unit 130 are integrally configured, there is no need to configure the receiving optical unit 120 separately for each channel.

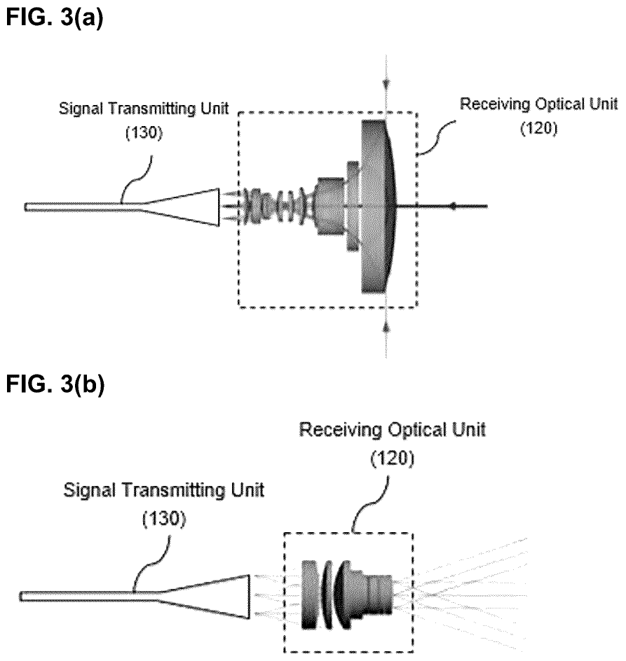

In this case, it is preferable that the signal transmitting unit 130 uses an optical fiber. For example, in the present invention, the optical fiber may be a tapered fiber in which one side thereof is formed to have a wider area than the other side thereof and which is gradually tapered from the one side to the other side (see FIG. 3(a) and FIG. 3(b)).

The signal processing module 140 executes a function of calculating distance information of the object based on the reflection signals for each channel inputted through the signal transmitting unit 130.

That is, distance information about a distance to a specific object to be measured is specifically confirmed by comparing the laser emitted through the transmitting optical unit 110 provided for each channel and the reflection signal for each channel received through the signal transmitting unit 130 by the receiving optical unit 120.

FIG. 3(a) and FIG. 3(b) are a diagram illustrating an example in which the receiving optical unit and the signal transmitting unit are integrally formed in the FMCW LiDAR system according to an embodiment of the present invention.

As illustrated in FIG. 3(a) and FIG. 3(b), the FMCW LiDAR system 100 according to an embodiment of the present invention is configured to integrate the receiving optical unit 120 and the signal transmitting unit 130.

In other words, when the multiple channel transmitting optics and the multiple channel receiving optics are configured, the transmitting optical unit is configured independently for each channel, and the receiving optical unit is integrally configured to enable simultaneous reception of reflection signals for each channel. Accordingly, the assembly and manufacturing processes are simplified by lowering the alignment difficulty in terms of process.

In this case, the receiving optical unit 120 is configured to include at least one lens having different shapes and sizes.

That is, in the present invention, it is possible to increase the reception rate of the reflection signal for each channel reflected from the object and reduce the reception error through the combination of lenses having different shapes and sizes.

For example, as illustrated in FIG. 3(a), when a large lens is disposed on the outermost side to which the reflection signal reflected from the object is inputted and a lens for condensing and collimating the reflection signal is disposed at the rear end thereof, it is possible to improve the measurement field of view in the vertical and vertical directions. Likewise, as illustrated in FIG. 3(b), when a lens for condensing and collimating light is disposed on the outermost side to which the reflection signal reflected from the object is inputted, it is possible to improve the measurement field of view in the left and right horizontal directions.

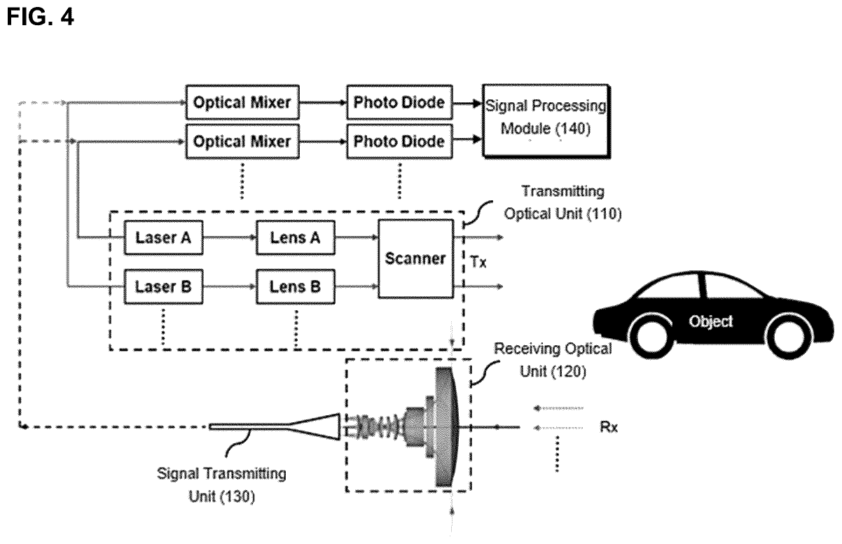

FIG. 4 is a detailed diagram illustrating the configuration of the FMCW LiDAR system with the integrated receiving optics for multiple channels according to an embodiment of the present invention.

FIG. 4 is an embodiment of the FMCW LiDAR system 100 to which the structure illustrated in (a) of FIG. 3 is applied. A laser for measuring a distance to an object is emitted through the transmitting optical unit 110 to one channel including laser A, lens A, and a scanner and another channel including laser B, lens B, and a scanner. In this case, two channels are used as an example, but the number of channels may increase.

The receiving optical unit 120 simultaneously receives reflection signals for each channel reflected from the object, and the simultaneously received reflection signals are transmitted through an optical mixer and a photo diode to the signal processing module 140 via the signal transmitting unit 130 integrally provided on one side of the receiving optical unit 120.

The signal processing module 140 calculates distance information of the object based on the laser emitted for each channel and the reflection signal reflected from the object and transmitted through the signal transmitting unit 130. That is, the distance between the FMCW LiDAR system 100 and a specific object is calculated by interfering two different signals, i.e., the laser emitted through the transmitting optical unit 110 and the reflection signal reflected from the object.

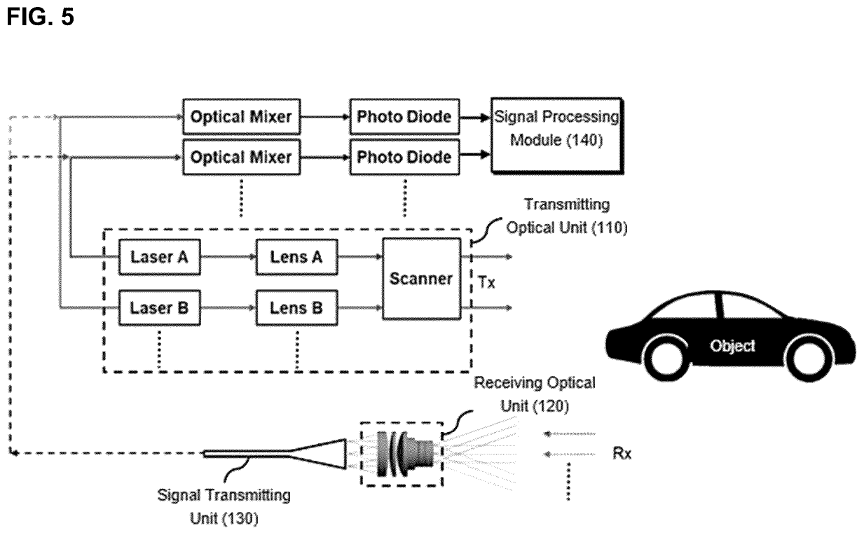

FIG. 5 is a diagram detail illustrating the configuration of an FMCW LiDAR system with an integrated receiving optics for multiple channels according to another embodiment of the present invention.

FIG. 5 is an embodiment of the FMCW LiDAR system 100 to which the structure illustrated in FIG. 3(b) is applied. Since the operation of each configuration is performed in the same manner as the configuration of FIG. 4, a detailed description thereof is omitted herein.

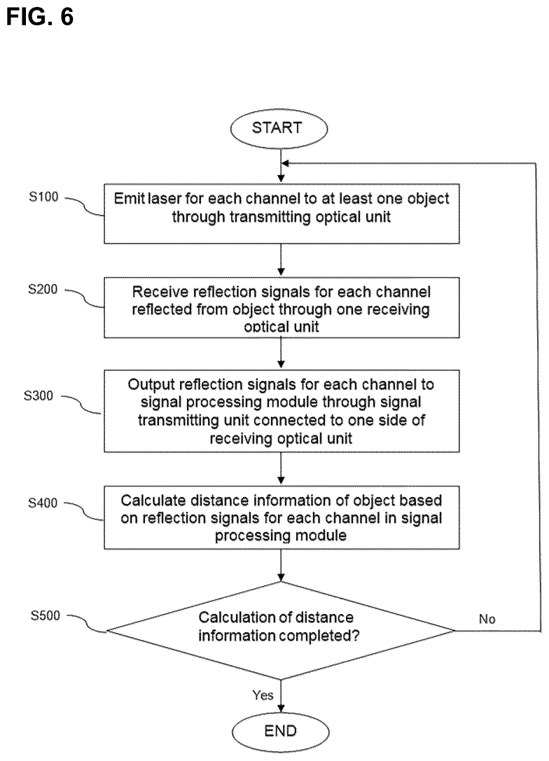

Next, an embodiment of an operating method of the FMCW LiDAR system with the integrated receiving optics for multiple channels, as configured above, according to the present invention will be described in detail with reference to FIG. 6. The order of each step according to the method of the present invention may be changed depending on the usage environment or those of ordinary skill in the art.

FIG. 6 is a flowchart showing in detail the operation process of the operating method of the FMCW LiDAR system with the integrated receiving optics for multiple channels according to an embodiment of the present invention.

As illustrated in FIG. 6, the FMCW LiDAR system 100 with the integrated receiving optics for multi-channel according to an embodiment of the present invention performs a step of collimating a laser into parallel light for each channel through at least one transmitting optical unit 110 and outputting the collimated light to at least one object (S100).

Thereafter, the FMCW LiDAR system 100 performs a step of simultaneously receiving reflection signals for each channel reflected from the at least one object through the receiving optical unit 120 (S200).

When the reflection signals reflected from the object are simultaneously received for each channel through in step S200, the FMCW LiDAR system 100 performs a step of outputting the reflection signal received for each channel to the signal processing module through the signal transmitting unit 130 integrally connected to one side of the receiving optical unit 120 (S300).

The signal processing module 140 performs a step of calculating distance information about a distance to the object based on the laser emitted for each channel by each transmitting optical unit 110 in step S100 and the reflection signals simultaneously received for each channel in step S300 (S400).

In addition, the FMCW LiDAR system 100 determines whether the calculation of the distance information of the object is completed (S500), and repeatedly performs steps S100 to S400 until the FMCW LiDAR system 100 determines that the calculation of the distance information of the object is completed.

On the other hand, the transmitting optical unit 110 may be independently configured one by one for the number of channels, and may output light having different frequencies for each channel.

In addition, only one receiving optical unit 120 is provided regardless of the number of transmitting optical units, and the signal transmitting unit 130 including the optical fiber is integrally connected to the rear end thereof. As described above, the receiving optical unit 120 is configured to simultaneously receive reflection signals of all channels and output the received reflection signals to the signal processing module 140 through the signal transmitting unit 130.

As described above, in a frequency modulated continuous wave (FMCW) light detection and ranging (LiDAR) system with an integrated receiving optics for multiple channels, assembly and manufacturing processes can be simplified by lowering the difficulty of the process through an integrated receiving optics for multiple channels in which a lens assembly and a tapered optical fiber are integrated, a transmitting optics can be infinitely expanded, angular resolution for vertical and horizontal field of view can be improved, and noise and signal-to-noise (SNR) degradation due to crosstalk caused by the use of an existing optical circulator can be prevented by using a transmitting optics and a receiving optics separately.

However, the effects of the present invention are not limited to those described above, and the effects not mentioned will be clearly understood from the present specification and accompanying drawings by those of ordinary skill in the art.

In order to more clearly express the technical spirit of the present invention, components that have no relevance to the technical spirit of the present invention are briefly expressed or omitted in the accompanying drawings.

Although the configurations and features of the present invention have been described with reference to the embodiments of the present invention, the present invention is not limited thereto, and it will be apparent to those of ordinary skill in the art that various changes or modifications can be made thereto without departing from the spirit and scope of the present invention. Therefore, it is noted that these changes or modifications will fall within the scope of the appended claims.

### DESCRIPTION OF SYMBOLS

100: FMCW LiDAR system
110: transmitting optical unit
120: receiving optical unit
130: signal transmitting unit
140: Signal processing module

What is claimed is:

1. A frequency modulated continuous wave (FMCW) light detection and ranging (LiDAR) system with an integrated receiving optics for multiple channels, the FMCW LiDAR comprising:
a receiving optical unit configured to receive reflection signals for each channel reflected from at least one object; and
a signal transmitting unit connected to one side of the receiving optical unit,
wherein the receiving optical unit and the signal transmitting unit are integrally formed to simultaneously receive the reflection signals for each channel.

2. The FMCW LiDAR of claim 1, further comprising:
at least one transmitting optical unit configured to collimate a laser into parallel light and outputs the collimated light; and
a signal processing module configured to calculate distance information of the object based on the reflection signal inputted through the signal transmitting unit.

3. The FMCW LiDAR of claim 2, wherein the transmitting optical unit is configured independently for each channel to emit a laser to each of the at least one object.

4. The FMCW LiDAR of claim 3, wherein the number of the transmitting optical unit is increased according to an increase in the number of channels, so as to improve angular resolution for a horizontal or vertical measurement field of view.

5. The FMCW LiDAR of claim 3, wherein the receiving optical unit is configured to simultaneously receive the reflection signals outputted for each channel and reflected from the at least one object and to output the simultaneously received reflection signals to the signal processing module through the signal transmitting unit.

6. The FMCW LiDAR of claim 3, wherein the transmitting optical unit is configured to adjust a frequency differently for each channel.

7. The FMCW LiDAR of claim 1, wherein the signal transmitting unit is an optical fiber that is a tapered fiber in which one side thereof is formed to have a wider area than the other side thereof and which is gradually tapered from the one side to the other side.

8. The FMCW LiDAR of claim 1, wherein the receiving optical unit includes at least one lens having different shapes and sizes, so as to increase a reception rate of the reflection signal and reduce a reception error based on a combination of the at least one lens.

9. The FMCW LiDAR of claim 2, wherein the FMCW LiDAR system independent uses the receiving optical unit and the transmitting optical unit, so as to prevent noise and a decrease in signal-to-noise ratio (SNR) due to crosstalk.

10. An operating method of a frequency modulated continuous wave (FMCW) light detection and ranging (LiDAR) system with an integrated receiving optics for multiple channels, the operating method comprising:
collimating a laser beam into parallel light for each channel through at least one transmitting optical unit and outputting the collimated light to at least one object;
simultaneously receiving reflection signals for each channel reflected from the at least one object through a receiving optical unit;
outputting the reflection signals received for each channel to a signal processing module through a signal transmitting unit integrally connected to one side of the receiving optical unit; and
calculating distance information of the object based on the reflection signals received for each channel through the signal processing module.
